(19) United States
(12) Patent Application Publication
(10) Pub. No.: US 2002/0130891 A1
(43) Pub. Date: Sep. 19, 2002

(54) TEXT DISPLAY WITH USER-DEFINED APPEARANCE AND AUTOMATIC SCROLLING

(76) Inventor: MICHAEL SINGER, PACOIMA, CA (US)

Correspondence Address: BLAKELY SOKOLOFF TAYLOR & ZAFMAN LLP, 12400 WILSHIRE BOULEVARD, SEVENTH FLOOR, LOS ANGELES, CA, 90025

(21) Appl. No.: 09/458,120

(22) Filed: Dec. 8, 1999

(51) Int. Cl. G09G 5/34

(52) U.S. Cl. 345/684

(57) ABSTRACT

A text document, such as may be retrieved using an Internet browser, is displayed in a dedicated display window with predefined type, size and style characteristics. The document in the display window may be automatically scrolled at a predefined rate.

### BACKGROUND OF THE INVENTION

1. Field of the Invention

The present invention relates generally to the field of computer displays. More particularly, the present invention provides a user-defined window in which text is displayed with predefined preferences as to type size, font and style and may be automatically scrolled at a user-defined rate.

2. Background

The phenomenal growth of Internet-based services has made a wealth of information readily available to the general public. Much of the information comprises text documents. To assimilate the information, an individual must display the text documents on a computer screen. Except for the shortest of documents, the individual must scroll the display in order to view an entire document. The actual display area available for a text document may be limited by the frame design of the website and the user's browser. Thus, reading a lengthy text document can become tedious.

The traditional approach to scrolling through a document requires the use of a computer mouse or other cursor positioning device to control a “scroll bar”, generally located at the edge of the window or frame. In some applications, scrolling can be accomplished by positioning the cursor at the edge of the window or frame corresponding to the direction in which the user wishes to view hidden portions of the document. Particular implementations of cursor-controlled scrolling are described, for example, in U.S. Pat. Nos. 5,485,174 and 5,874,936.

One approach to making it easier to scroll through a document has been the addition of a roller control on a computer mouse. Movement of the roller control is interpreted as a scrolling command. Such a device is disclosed in U.S. Pat. No. 5,530,455. While a roller mouse makes it easier to scroll through a text document, the document still appears within the same window and frame.

Except for the ability to manually scroll through a document, the words of a text document are static on the screen. A reader's eyes flow over them at various speeds depending upon several factors, including, but not limited to the following:

1. The impact of the page layout;

2. The width of the column of text;

3. The rate at which one scrolls down the page utilizing a mouse or other pointing device;

4. The speed of the computer; and

5. The nature of the graphics on the page.

### SUMMARY OF THE INVENTION

The present invention provides a method and apparatus by which a text document, such as may be retrieved using an Internet browser, is displayed in a dedicated display window with predefined type, size and style characteristics. The document in the display window may be automatically scrolled at a predefined rate.

### BRIEF DESCRIPTION OF THE DRAWINGS

FIG. 1 is a functional block diagram of a system in which the present invention may be implemented.

FIG. 2 illustrates a text document retrieved using an Internet browser program.

FIG. 3 illustrates the text display window of the present invention.

FIG. 4 is a functional flow diagram of the method of the present invention.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

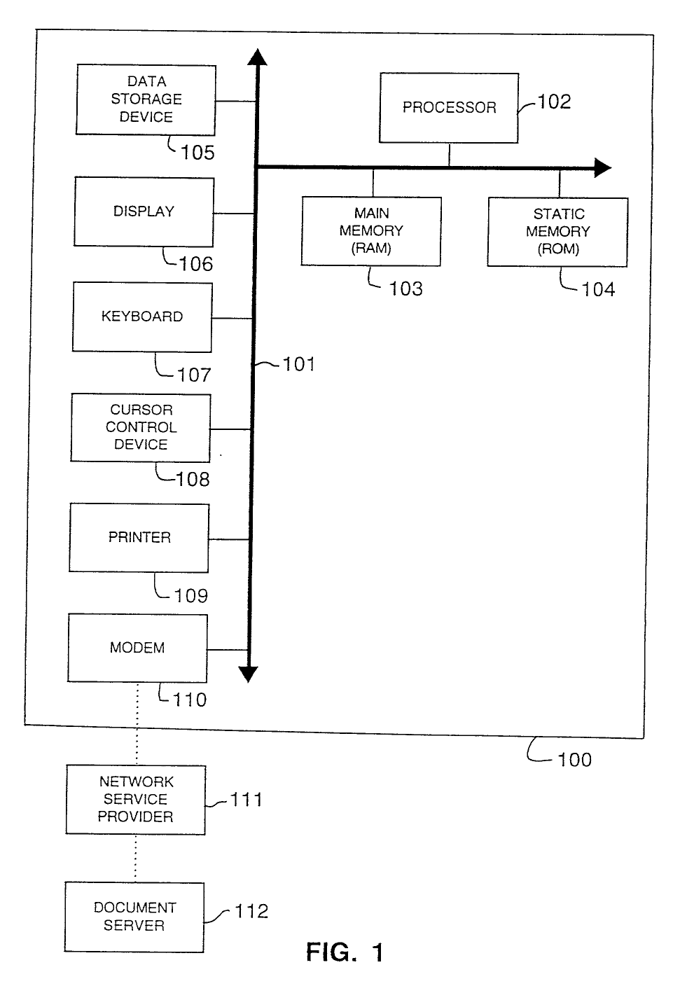

FIG. 1 is a functional block diagram of a system, including a general purpose computer 100, suitable for implementing the present invention. Computer 100 may be any of the types of widely available personal computers, and typically comprises a bus or other communication means 101 for communicating information, a processing means 102 coupled to the bus 101 for processing information, a random access memory (RAM) or other storage device 103 (commonly referred to as a main memory) coupled to the bus 101 for storing information and instructions for processor 102, a read only memory (ROM) or other static storage device 104 coupled to the bus 101 for storing static information and instructions for processor 102, a data storage device 105, such as a magnetic disk and disk drive, coupled to the bus 101 for storing information and instructions, a display device 106, such as a cathode ray tube, liquid crystal display, etc, coupled to the bus 101 for displaying information to the computer user, an alphanumeric input device 107 such as a keyboard, including alphanumeric and other keys coupled to the bus 101 for communicating information and command selections to processor 102, and a cursor control device 108, such as a mouse, track-ball, cursor control keys, etc, coupled to the bus 101 for communicating information and command selections to processor 102 and for controlling cursor movement. The cursor control device 108 typically includes at least one switch for issuing “point and click” commands to processor 102. It is useful if the system also includes a hardcopy output device 109, such as a printer, for providing permanent copies of information.

Computer 100 preferably includes a device, such as modem 110, for connecting to a data communication network. Typically, the network is a telecommunication network, but other types of networks are also within the scope of the invention. The network enables computer 100 to communicate with a remote document server 112. With current technology, this is typically accomplished via a network service provider 111. Document server 112 may be any of the multitude of servers accessible via the World Wide Web. A user of computer 100 can download a document from server 112 for display on display device 106. This is typically accomplished using an Internet browser program that is permanently stored in the data storage device 105 and is loaded into main memory 103 for controlling the operation of processor 102.

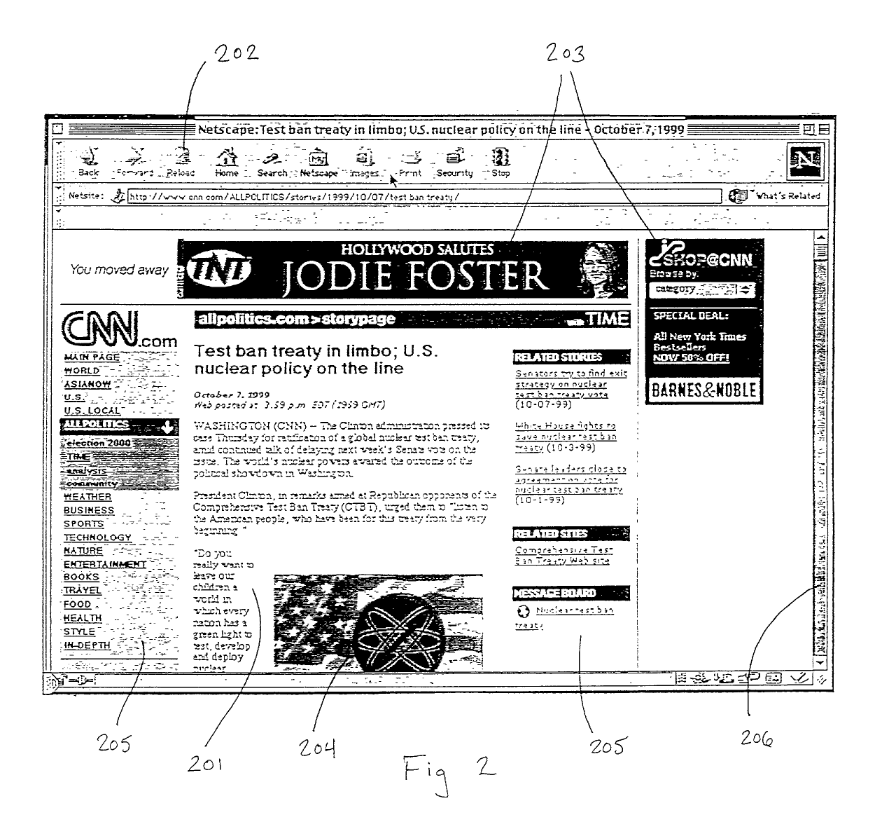

Referring now to FIG. 2, a computer display screen is shown in which a text document 201 has been retrieved using an Internet browser program, in this case Netscape Navigator®. It will be noted that only a relatively small portion of the display screen is devoted to document 201. The remainder of the display screen is devoted to the browser program's toolbar 202, advertising 203, graphics 204 and web page information 205. In order to read the entire document 201, the user must use scroll bar 206. Because only a small portion of the display screen is devoted to document 201, the type size is necessarily small, making the document difficult to read for many. Moreover, the type style specified by the website information provider may not be optimized for legibility. In addition, an individual reading document 201 is likely to be distracted by the surrounding text and graphics, some of which may be flashing or animated.

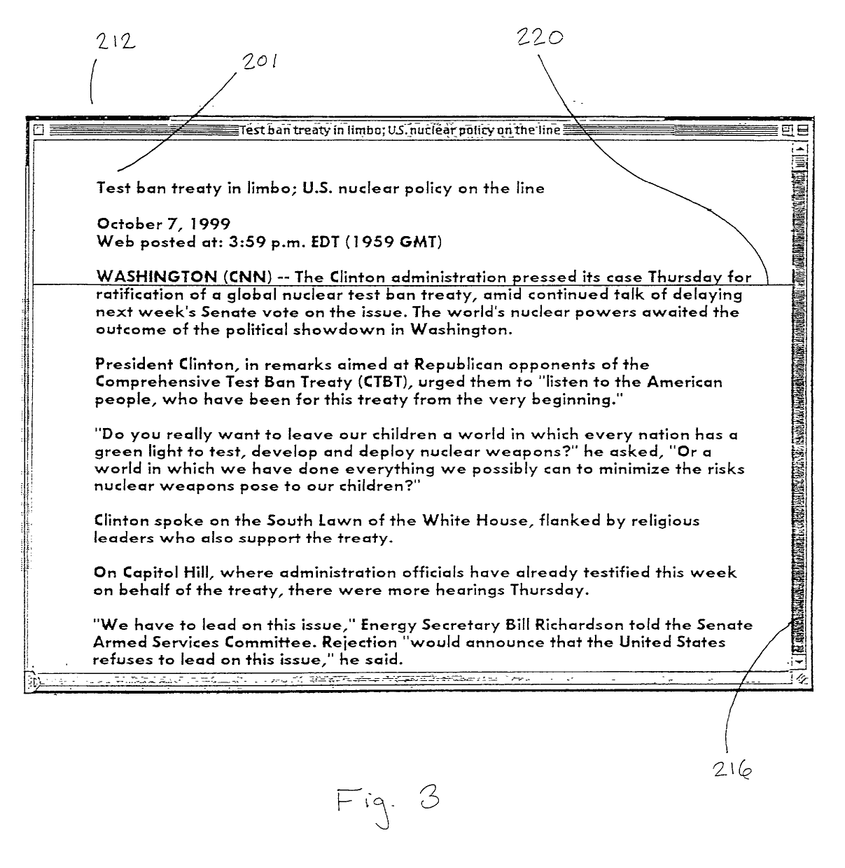

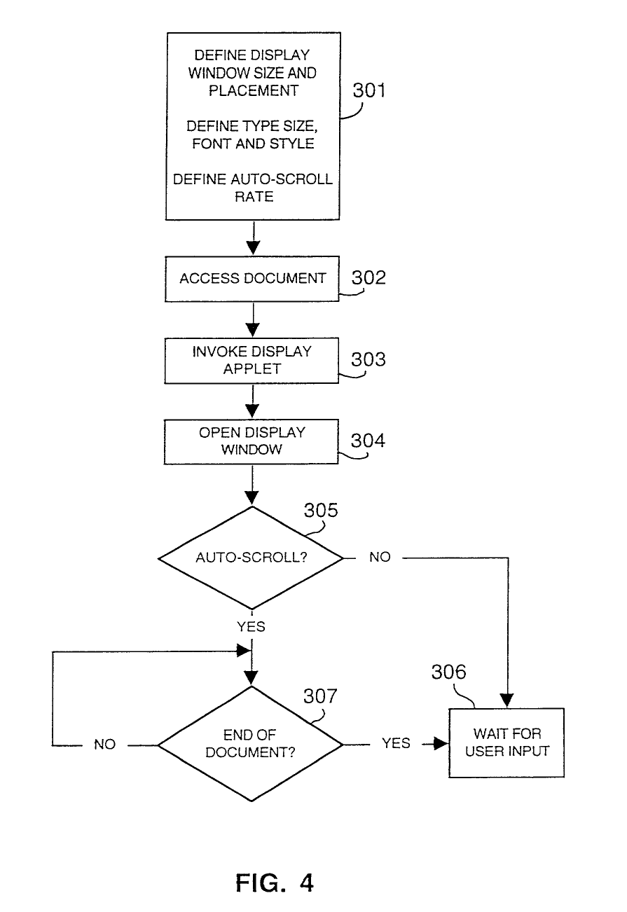

FIG. 3 illustrates the same text document 201 on a computer display using the present invention. Here, virtually the entire display area is devoted to document 201. The document display window may include a toolbar 212 and scroll bar 216. The text of the document is displayed in a type size, font and style selected by user. A particular advantage of the present invention is that document 201 may be automatically scrolled at a rate selected by the user. Thus, once a document has been selected for viewing, the user may read the entire document without having to manually scroll through it. A sight line or cursor 220 may be provided to assist the user, particularly one who is adept at speed reading. The sequence of operations for utilizing the present invention is illustrated in FIG. 4. Preliminarily, the user defines various display parameters in step 301. These may include the display window size and placement on the computer screen, the type size, font and style to be utilized for the display of documents and the rate for automatic scrolling. Automatic scrolling may be enabled or disabled at the user's discretion. For this purpose, an appropriate menu selection may be provided in the display window toolbar 212. If not specified by the user, default settings for the various user-defined parameters will be used.

Apart from the appearance of text and automatic scrolling, the user may be able to customize the display in other ways. For example, the user may choose to deliver to the screen any number of words (“text unit”) at a time. Some users may prefer to read word by word; others may prefer to read one sentence at a time; and others may prefer several sentences. Furthermore, the user may choose from a variety of techniques to move from the delivery of one text unit to another. These may include dissolves, simple cuts, fades, sparkles and other techniques commonly used in film and video editing.

Tool bar 212 may include buttons to control various functions, such as:

Stop

Pause

Fast Forward/Reverse

Increase Speed/Reduce Speed

Brighten/Darken

Color Variation

Font Size, Type Face

Size of Reading Window

The tool bar buttons can be left visible or can be hidden and made to reappear with a click of the computer pointing device.

At step 302, the user accesses a text document. As discussed above, this may be a document obtained from a website using an Internet browser program. However, the invention is not limited in this regard. The text document 201 may also be obtained from local or remote storage media or from any other electronic source. Once a document has been accessed, the user invokes a display applet at step 303. This may be accomplished from a system level menu or a toolbar. The applet opens the display window at step 304. In accordance with the user's preference settings, the display window may completely overlay the underlying application window or only a portion thereof. The text of the accessed document is then automatically displayed in the selected type size, font and style.

The applet checks at step 305 to see if automatic scrolling has been selected. If not, the applet awaits a user input at step 306. The user may manually scroll through the document in a conventional manner using a scroll bar 216 or select any other action enabled by the toolbar 212, such as closing the display window, printing the document, etc. If automatic scrolling is enabled, the document is scrolled at the predefined rate until the end of the document is reached as determined at step 307. The applet again awaits a user input. Alternatively, the display window may be automatically closed after a suitable pause once the end of the document is reached so that the user is automatically returned to the underlying application, e.g., the Internet browser program.

A number of optional features may be incorporated with the present invention, such as:

Comprehension Quizzers

Users may utilize and customize “comprehension quizzers”, which convert text facts into questions that query the reader at specified intervals to determine comprehension levels and help keep the reader focused.

Vocabulary Builders

The user may link the text window to a dictionary web site or local dictionary/thesaurus to immediately obtain information by clicking on the appropriate word and selecting the desired function. Each word selected for vocabulary functions would be automatically listed in a “new word review”, which can be presented at desired frequencies as a quiz with multiple choices and scoring or as a simple list with definitions, synonyms and/or antonyms.

Statistical Functions

The text window of the present invention may be used to deliver facts about reading rates, words per minute, comprehension levels and show percentile level on a variety of the words in the text. It may also report percentage completed and estimated time of completion for a page, an article or a chapter of an entire book.

Quick Search Link

The user may select a topic, a word or a series of words in the text window and may have a tool bar button or other control to initiate a “one-click search” that delivers the selected text to the search index of a pre-selected search engine.

It will be recognized that the above described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A method of displaying a text document on a computer display screen comprising:
connecting the computer to a document storage device;
loading a text document into the computer from the document storage device;
displaying the text document in a display window with predetermined text characteristics; and
automatically scrolling the text document at a predetermined rate.

2. The method of claim 1 wherein the document storage device is remote from the computer.

3. The method of claim 2 wherein the computer is connected to the document storage device via a global computer network.

4. The method of claim 3 wherein the text document is loaded from the document storage device using a computer network browser program.

5. The method of claim 1 further comprising displaying a fixed cursor in the display window.

6. The method of claim 1 wherein the text characteristics comprise type size.

7. The method of claim 1 wherein the text characteristics comprise type font.

8. The method of claim 1 wherein the text characteristics comprise type style.

9. A method of displaying a text document on a computer display screen comprising:
connecting the computer to a document service on a global computer network;
loading a text document into the computer from the document server using a computer network browser program; and
displaying the text document in a display window separate from the browser program window.

10. The method of claim 9 wherein the text document is displayed in the display window with predetermined text characteristics.

11. The method of claim 10 wherein the predetermined text characteristics comprise type size.

12. The method of claim 10 wherein the predetermined text characteristics comprise type font.

13. The method of claim 10 wherein the predetermined text characteristics comprise type style.

14. The method of claim 9 further comprising scrolling the text document at a predetermined rate.

15. An information delivery system comprising:
a computer coupled to a data communication network.
a document storage device coupled to the data communication network.
software controlling the computer to load a text document into the computer from the document storage device, display the text document in a display window with predetermined text characteristics, and automatically scroll the text document at a predetermined rate.
